(19) United States
(12) Patent Application Publication
(10) Pub. No.: US 2015/0330542 A1
(43) Pub. Date: Nov. 19, 2015

(54) COUPLING DEVICE FOR TUBULAR MEMBERS

(71) Applicants: Chu Yu LIN, Taichung (TW); Yen Chen LIN, Taichung (TW)

(72) Inventors: Chu Yu LIN, Taichung (TW); Yen Chen LIN, Taichung (TW)

(21) Appl. No.: 14/572,819

(22) Filed: Dec. 17, 2014

(30) Foreign Application Priority Data
May 16, 2014 (TW) 103208578

(51) Int. Cl. F16L 19/04

(52) U.S. Cl. CPC F16L 19/043

(57) ABSTRACT

A coupling device includes a tubular member having an outer thread, and having a number of pawls extended axially and outwardly from the tubular member, a coupler having end portion engaged into the tubular member and having an engaging member provided on the coupler, and a lock nut includes an inner thread engaged with the tubular member for securing the tubular member and the lock nut together, the lock nut includes a radially and inwardly extended peripheral flange for engaging with the pawls of the tubular member and for forcing the pawls to move inwardly toward the coupler and to engage with the engaging member of the coupler and to secure the coupler to the tubular member.

### BACKGROUND OF THE INVENTION

1. Field of the Invention

The present invention relates to a coupling device or tube fitting device, and more particularly to a coupling device including an improved structure or configuration for solidly and stably connecting or coupling two or more tubular members together and for preventing the fluid or hydraulic oil from leaking from the tubular members which may subject great hydraulic pressures or the like.

2. Description of the Prior Art

Typical tube fitting devices or coupling devices for tubular members or for joining segments of plastic pipes or metal tubes comprise a fitting or adapter or fastener for securing the end portions of the tubular members or joining segments of plastic pipes or metal tubes together, where the tubular members or joining segments of plastic pipes or metal tubes may subject great hydraulic pressures or the like.

For example, U.S. Pat. No. 4,915,427 to Zahurance, U.S. Pat. No. 5,037,143 to Sanders et al., U.S. Pat. No. 5,121,949 to Reese, U.S. Pat. No. 5,351,998 to Behrens et al., U.S. Pat. No. 5,681,058 to Hwang, U.S. Pat. No. 5,934,714 to Sugiyama et al., and U.S. Pat. No. 6,345,845 to Johnston disclose several of the typical tube fitting devices or coupling devices for tubular members each also comprising a fitting or adapter or fastener for securing the end portions of the tubular members or joining segments of plastic pipes or metal tubes together and for preventing the fluid or hydraulic oil from leaking from the tubular members.

However, the end portions of the tubular members or joining segments of plastic pipes or metal tubes are normally secured together with radially compressing or friction forces and may have a good chance to be disengaged from each other due to the great hydraulic pressures or the like existed within the tubular members or the pipes or tubes.

The present invention has arisen to mitigate and/or obviate the afore-described disadvantages of the conventional coupling devices for tubular members.

### SUMMARY OF THE INVENTION

The primary objective of the present invention is to provide a coupling device including an improved structure or configuration for solidly and stably connecting or coupling two or more tubular members together and for preventing the fluid or hydraulic oil from leaking from the tubular members which may subject great hydraulic pressures or the like.

In accordance with one aspect of the invention, there is provided a coupling device comprising a tubular member including a first end portion, and a second end portion having a chamber formed therein, the tubular member including an outer thread provided thereon, and including a number of pawls extended axially and outwardly from the second end portion of the tubular member, a coupler including a first end portion engaged into the chamber of the tubular member, and including a second end portion extended out of the tubular member, and including an engaging member provided on the coupler, and a lock nut including an inner thread formed therein for engaging with the outer thread of the tubular member for securing the tubular member and the lock nut together, the lock nut including a peripheral flange extended radially and inwardly therefrom for engaging with the pawls of the tubular member and for forcing the pawls to move radially and inwardly toward the coupler and to engage with the engaging member of the coupler and to secure the coupler to the tubular member.

The engaging member of the coupler is an outer peripheral rib extended axially and outwardly from the coupler for engaging with the pawls of the tubular member. The coupler includes a sealing ring engaged onto the coupler and engaged with the tubular member for making a water tight seal between the coupler and the tubular member. The tubular member includes a non-circular segment provided thereon.

The lock nut includes an inner peripheral surface formed on the peripheral flange for engaging with the pawls of the tubular member, and the inner peripheral surface of the lock nut is preferably selected from a tilted and inclined inner peripheral surface. The tubular member includes a cylindrical member, and the pawls are extended from the cylindrical member. For example, the cylindrical member includes an outer thread for engaging with an outer thread of the tubular member and for detachably anchoring or securing the cylindrical member to the tubular member and for allowing the cylindrical member to be detached from the tubular member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a coupling device for tubular members in accordance with the present invention;

FIG. 2 is a partial exploded view illustrating some of the parts or elements of the coupling device, in which a portion of the coupling device has been cut off for showing the inner structure of the coupling device;

FIG. 3 is a cross sectional view of the coupling device;

FIG. 4 is another cross sectional view similar to FIG. 3, illustrating the operation of the coupling device;

FIG. 5 is another exploded view similar to FIG. 1, illustrating the other arrangement of the coupling device; and

FIG. 6 is a cross sectional view of the coupling device as shown in FIG. 5.

### DETAILED DESCRIPTION OF THE PREFERRED EMBODIMENT

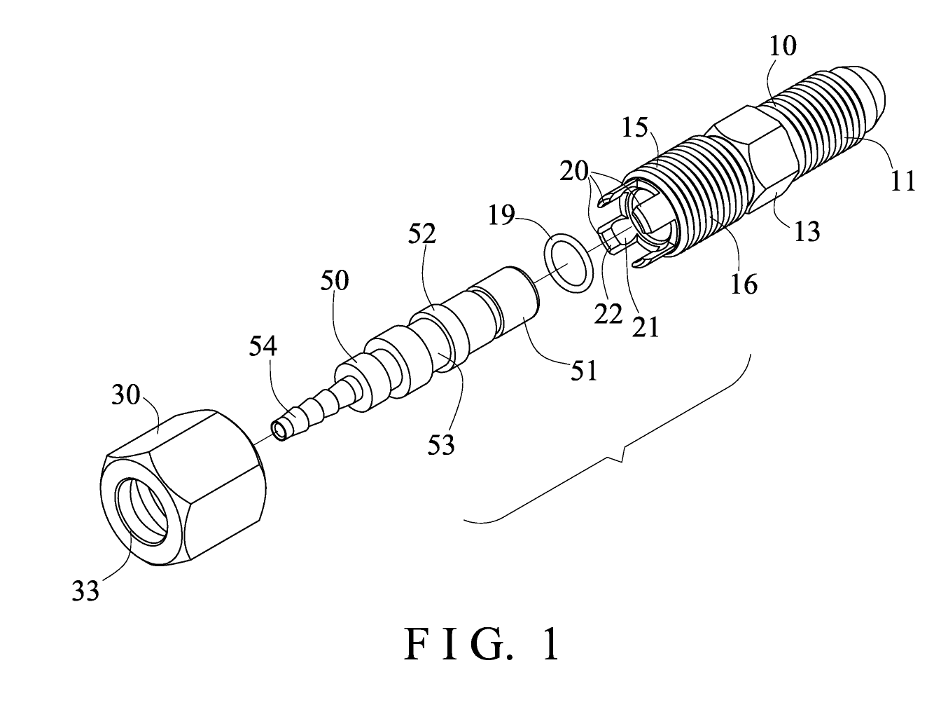

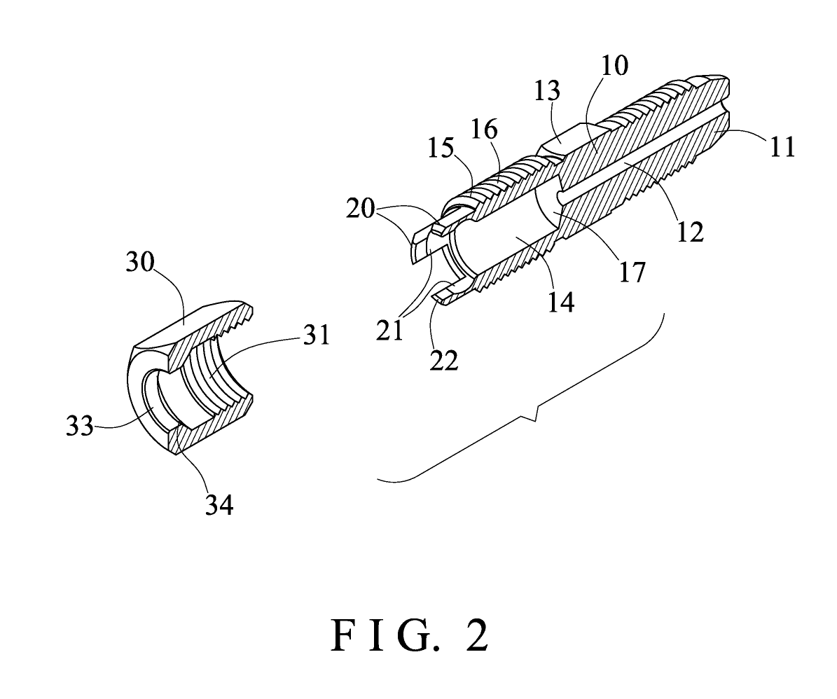

Referring to the drawings, and initially to FIGS. 1-3, a coupling device in accordance with the present invention is provided for connecting or coupling two or more tubular members or joining segments of plastic pipes or metal tubes together and for preventing the fluid or hydraulic oil from leaking from the tubular members which may subject great hydraulic pressures or the like, the coupling device comprises a first or primary tubular member 10 including one or first end portion 11 having a conduit or passage 12 formed therein for connecting or coupling to a fluid or hydraulic oil reservoir (not illustrated) and for receiving the fluid or hydraulic oil therefrom, and including a non-circular portion or segment 13 formed or provided on the middle or intermediate portion thereof for allowing the tubular member 10 to be selectively rotated or driven relative to the fluid or hydraulic oil reservoir (not illustrated) by the driving tools or the like (not illustrated).

The tubular member 10 further includes a compartment or chamber 14 formed therein, such as formed in the other or second end portion 15 thereof and communicating with the passage 12 of the tubular member 10 for receiving the fluid or hydraulic oil from the fluid or hydraulic oil reservoir (not illustrated), and includes an outer thread 16 or the like formed or provided on the other or second end portion 15 thereof for threading or engaging with a fastener or lock nut 30, for example, the lock nut 30 includes an inner thread 31 formed therein for threading or engaging with the outer thread 16 of the tubular member 10 and for solidly and stably anchoring or securing the tubular member 10 and the lock nut 30 together, the chamber 14 of the tubular member 10 includes an inner diameter greater than that of the passage 12 of the tubular member 10 for forming or defining an inner peripheral shoulder 17 in the tubular member 10.

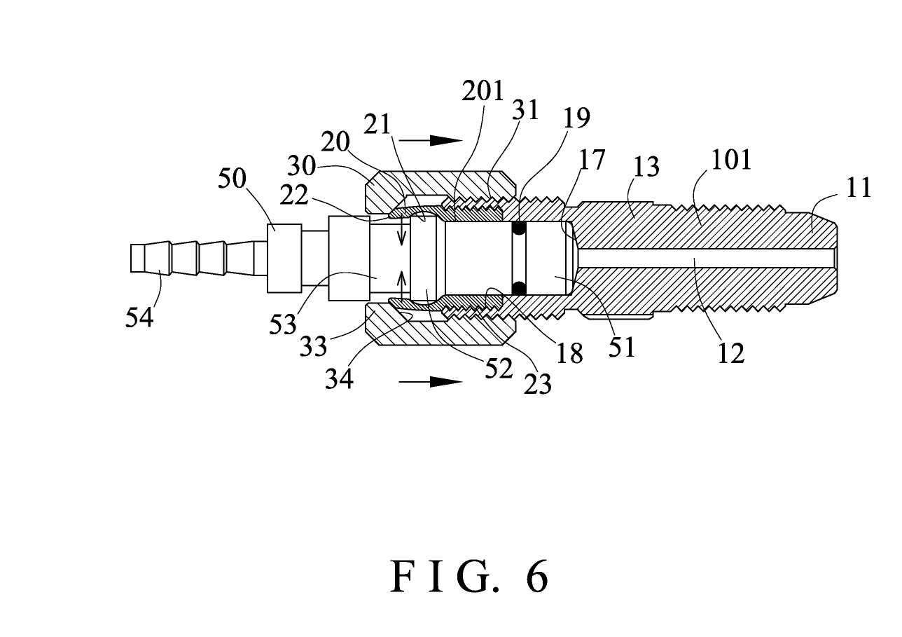

The tubular member 10 further includes one or more (such as four) gripping figures or pawls 20 extended axially and outwardly therefrom, such as extended axially and outwardly from the other or second end portion 15 of the tubular member 10, and the pawls 20 each include a recess or depression 21 formed therein for forming or defining a relative protrusion or projection 22, in which the depressions 21 of the pawls 20 are facing toward or communicating with the chamber 14 of the tubular member 10. The lock nut 30 includes a peripheral rib or flange 33 extended radially and inwardly therefrom for forming or defining an inner peripheral shoulder or surface 34, such as a tilted or inclined inner peripheral surface 34 in the lock nut 30 for selectively contacting or engaging with the pawls 20 of the tubular member 10 and for selectively compressing or forcing the pawls 20 to move radially and inwardly toward each other or into the chamber 14 of the tubular member 10 (FIGS. 4, 6).

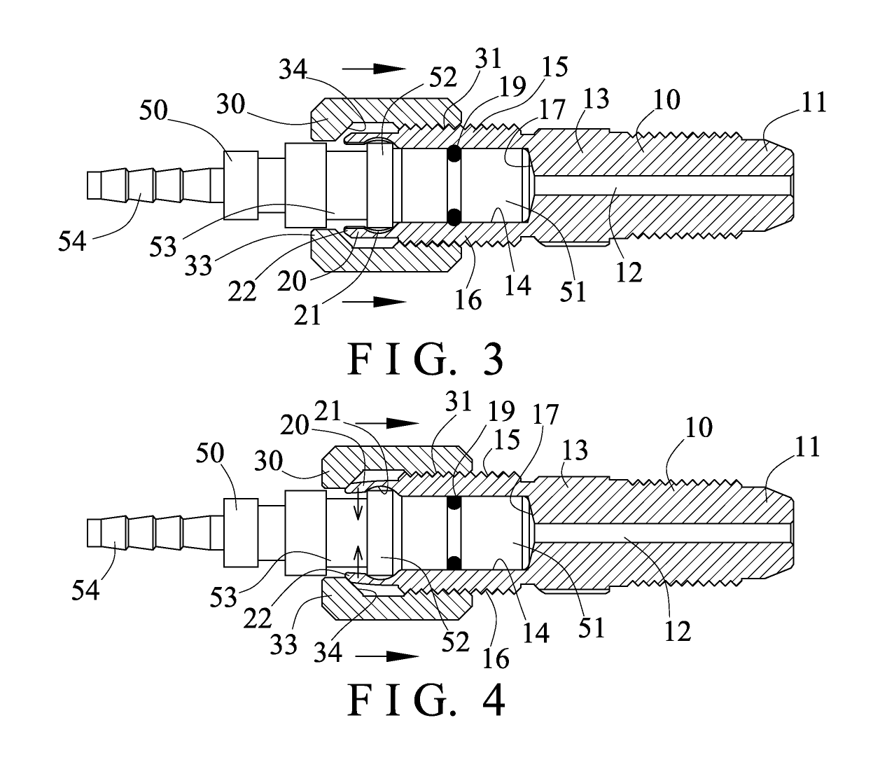

Another or second tubular member or coupler 50 includes one or first end portion 51 disposed or engaged into the chamber 14 of the tubular member 10 and contacted or engageble with the peripheral flange 33 and/or the inner peripheral surface 34 of the lock nut 30 (FIGS. 3, 4, 6) and for anchoring or positioning the coupler 50 to the tubular member 10 and for preventing the coupler 50 from being moved axially relative to the tubular member 10. It is preferable that a gasket or sealing ring 19 is engaged onto the coupler 50, such as engaged onto the first end portion 51 of the coupler 50 and contacted or engaged with the tubular member 10 for making an air or water tight seal between the coupler 50 and the tubular member 10. The coupler 50 further includes an engaging member 52 provided thereon, such as an outer peripheral protrusion or rib 52 extended axially and outwardly from the middle or intermediate portion 53 thereof for selectively engaging with the pawls 20 of the tubular member 10.

In operation, as shown in FIGS. 3 and 4, the peripheral rib 52 of the coupler 50 is aligned with the depressions 21 of the pawls 20 for selectively engaging with the depressions 21 and the projections 22 of the pawls 20 and for solidly and stably gripping or securing the coupler 50 to the tubular member 10 and for preventing the coupler 50 from being moved or disengaged from the tubular member 10 when the peripheral flange 33 and/or the inner peripheral surface 34 of the lock nut 30 are moved toward the pawls 20 and to move or force the pawls 20 radially and inwardly toward each other or into the chamber 14 of the tubular member 10 or toward the coupler 50 (FIGS. 4, 6). The coupler 50 includes an outer or free or second end portion 54 extended out of the tubular member 10 for selectively connecting or coupling to a fluid or hydraulic facility (not illustrated) and for suitably and safely supplying the fluid or hydraulic oil to the fluid or hydraulic facility (not illustrated).

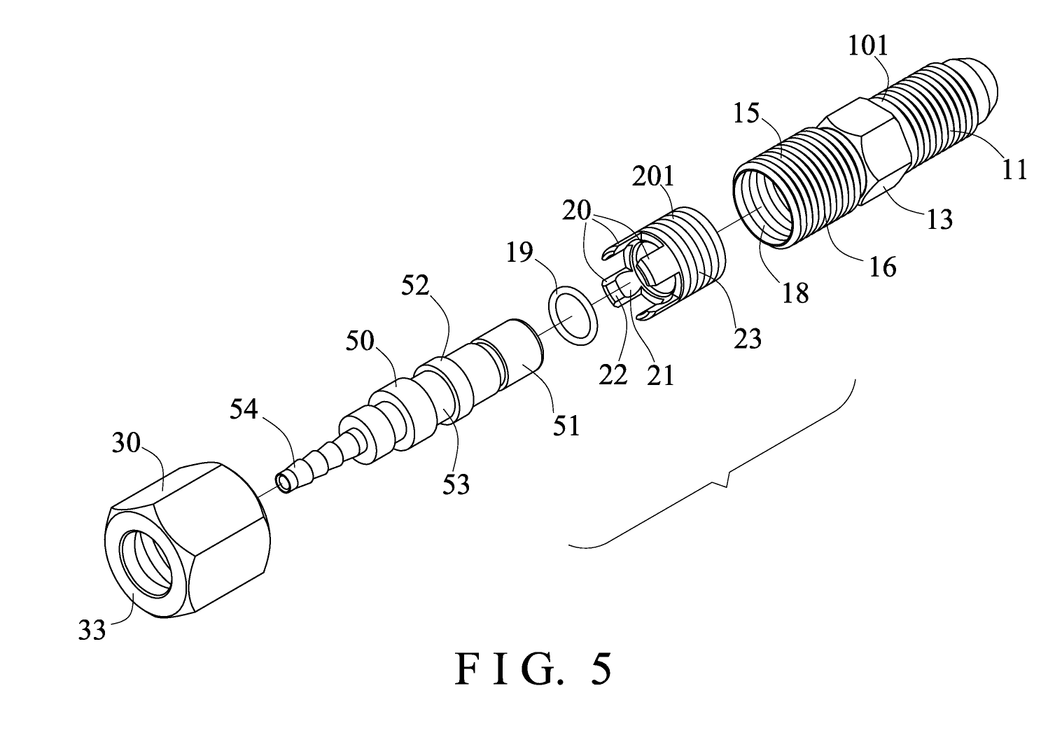

Alternatively, as shown in FIGS. 5 and 6, the tubular member 101 may include an inner screw hole 18 formed in the other or second end portion 15 thereof, and may include a cylindrical member 201 having an outer thread 23 formed or provided on the outer peripheral portion thereof for selectively threading or engaging with the inner thread 18 of the tubular member 101 and for detachably securing the cylindrical member 201 to the tubular member 101. The gripping figures or pawls 20 are extended axially and outwardly from the cylindrical member 201, instead of from the tubular member 101. Similarly, the pawls 20 of the cylindrical member 201 may also be moved or forced radially and inwardly toward each other or toward the coupler 50 by moving the peripheral flange 33 and/or the inner peripheral surface 34 of the lock nut 30 toward the pawls 20.

As shown in FIGS. 4 and 6, the pawls 20 of the tubular member 10 or of the cylindrical member 201 may be moved or forced radially and inwardly toward each other or toward the coupler 50, and the peripheral rib 52 of the coupler 50 may be engaged into or with the depressions 21 and/or the projections 22 of the pawls 20 by engaging the peripheral flange 33 and/or the inner peripheral surface 34 of the lock nut 30 with the pawls 20, such that the pawls 20 may grip or engage with the peripheral rib 52 of the coupler 50 and may solidly and stably secure and retain the coupler 50 to the tubular member 10 and thus may prevent the coupler 50 from being moved or disengaged from the tubular member 10 even when the tubular member 10 and the coupler 50 are subjected with great hydraulic pressures or the like.

Accordingly, the coupling device in accordance with the present invention includes an improved structure or configuration for solidly and stably connecting or coupling two or more tubular members together and for preventing the fluid or hydraulic oil from leaking from the tubular members which may subject great hydraulic pressures or the like.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A coupling device comprising:
a tubular member including a first end portion, and a second end portion having a chamber formed therein, said tubular member including an outer thread provided thereon, and including a plurality of pawls extended axially and outwardly from said second end portion of said tubular member,
a coupler including a first end portion engaged into said chamber of said tubular member, and including a second end portion extended out of said tubular member, and including an engaging member provided on said coupler, and
a lock nut including an inner thread formed therein for engaging with said outer thread of said tubular member for securing said tubular member and said lock nut together, said lock nut including a peripheral flange extended radially and inwardly therefrom for engaging with said pawls of said tubular member and for forcing said pawls to move radially and inwardly toward said coupler and to engage with said engaging member of said coupler and to secure said coupler to said tubular member.

2. The coupling device as claimed in claim 1, wherein said engaging member of said coupler is an outer peripheral rib extended axially and outwardly from said coupler for engaging with said pawls of said tubular member.

3. The coupling device as claimed in claim 1, wherein said coupler includes a sealing ring engaged onto said coupler and engaged with said tubular member for making a water tight seal between said coupler and said tubular member.

4. The coupling device as claimed in claim 1, wherein said lock nut includes an inner peripheral surface formed on said peripheral flange for engaging with said pawls of said tubular member.

5. The coupling device as claimed in claim 1, wherein said inner peripheral surface of said lock nut is an inclined inner peripheral surface.

6. The coupling device as claimed in claim 1, wherein said tubular member includes a non-circular segment provided thereon.

7. The coupling device as claimed in claim 1, wherein said tubular member includes a cylindrical member, and said pawls are extended from said cylindrical member.

8. The coupling device as claimed in claim 7, wherein said cylindrical member includes an outer thread for engaging with said tubular member and for securing said cylindrical member to said tubular member.
